(19) United States
(12) Patent Application Publication
(10) Pub. No.: US 2007/0205254 A1
(43) Pub. Date: Sep. 6, 2007

(54) Mailable wooden postcard and method

(76) Inventor: James A. Philbrick, Alton, ME (US)

Correspondence Address: ANTHONY D. PELLEGRINI RUDMAN & WINCHELL, LLC, 84 HARLOW STREET, P.O. BOX 1401, BANGOR, ME, 04402-1401, US

(21) Appl. No.: 11/369,090

(22) Filed: Mar. 6, 2006

(51) Int. Cl. B42D 15/00

(52) U.S. Cl. 229/92.8

(57) ABSTRACT

A solid wood postcard formed in the shape of a recognizable image in silhouette, such as a state or a local landmark, having a mailing graphic and a message graphic affixed thereto, whereby the postcard is suitably adapted to be placed directly in the mails for delivery without need for an envelope or exterior packaging; the postcard optionally bearing a graphic logo on either side, said graphic logo being optionally customizable, and the postcard also optionally prepared with appropriate postage affixed thereto, for the convenience of the purchaser. A method for preparing and delivering said postcard.

### BACKGROUND OF THE INVENTION

1. Technical Field

The invention relates generally to the field of postcards. More specifically, the invention is directed to an improved postcard constructed of wood which can be placed directly in the mails for delivery without need of an envelope or other packaging.

2. Description of Prior Art

Postcards are well known in the art. They typically are fashioned of heavy paper stock or cardboard. They may have a photograph or other image affixed to one side, and room for adding a message. Variations on this theme are found in previously issued patents, such as U.S. Pat. No. 2,256,399 to MacHarg (Sep. 16, 1941) for a “Mailing Card”, disclosing a paper postcard with a removable image; U.S. Pat. No. 3,894,684 to Florey (Jul. 15, 1975) for a “Picture Mailer”, disclosing a postcard having an attached envelope for carrying a photograph; U.S. Pat. No. 5,156,698 to Roberts (Oct. 20, 1992) for “Integral Packaging for Puzzle Postcard and Other Products and Method of Making”, disclosing a multi-layer postcard having a jigsaw puzzle contained within outer layers; U.S. Pat. No. 5,833,129 to Smith (Nov. 10, 1998) for “Picture Frame Post Card”, disclosing a foldable postcard with a removable panel to reveal a photograph contained between the folded portions; U.S. Pat. No. 6,216,378 to Roberto (Apr. 17, 2001) for “Photo-Frame Postcard Structure and Product”, disclosing a foldable postcard suitable for containing a photograph; U.S. Pat. No. 6,434,867 to Ristau (Aug. 20, 2002) for “Mailable Assemblage with Flexible Appendages and Method of Fabrication”, disclosing a multi-layer postcard with a graphical composite assembly disposed between two outer layers; and U.S. Pat. No. 6,615,516 to Houston, et al. (Sep. 9, 2003) for “Mailable Device with Graphic Display”, disclosing a multi-layer postcard with a graphic display disposed between two outer layers.

Postcards, however, have the disadvantage of being non-durable. They are subject to damage during mailing, and often become bent or torn even after receipt, simply in the course of storage of display. Postcards using multiple layers to protect the interior contents are fairly complicated to manufacture and tend to deviate from the spirit of a postcard. Plastic postcards require the use of materials which are non-biodegradable and require substantial processing, and thus are not amenable to local production as a cottage industry.

The present invention is an improvement over the prior art in that it is a wooden postcard, which can be mailed without damage and can serve as a durable souvenir. A postcard made of wood may also have an irregular perimeter design without fear of being torn, bent, or otherwise damaged during mailing. Such designs may be silhouettes of familiar objects, such as vacation landmarks, or the state in which a vacation was taken, or animal shapes. Unlike a wooden plaque, the present invention is suitably adapted to being placed directly in the mails without need for an envelope or other packaging, thus retaining the basic character of a postcard. A wooden postcard is also amenable to manufacture using local natural resources as a cottage industry.

It is therefore an objective of the present invention to provide an improved postcard constructed of wood that can be placed directly in the mails without need for an envelope or other packaging.

It is a further objective to provide an improved postcard constructed of wood that can be serve as a permanent souvenir.

It is yet a further objective to provide an improved postcard that can be easily manufactured from readily available natural resources as a cottage industry.

Other objectives of the present invention will be readily apparent from the description that follows.

### SUMMARY OF THE INVENTION

The present invention is a mailable wooden postcard and method for preparing and mailing same. The postcard has a top surface, a bottom surface, and a circumferential edge. The top surface has affixed thereto a mailing graphic, suitably adapted to contain appropriate mailing information, such as the recipient's name and address and the name and address of the sender. The top surface also has affixed thereto a message graphic, suitably adapted to contain a desired message. Alternatively, either or both of the mailing graphic and/or the message graphic may be affixed to the bottom surface. Information contained in the mailing graphic and the message graphic unique to the user is provided by the user by a marking device, such as an ink pen. The circumferential edge of the postcard defines a shape of a recognizable image in silhouette. This may be a landmark, the outline of a state, an animal silhouette, or any other suitable shape. Configured as such, the postcard is suitably adapted to be placed directly in the mails for delivery without need for an envelope or exterior packaging.

The postcard of the present invention may optionally comprise a graphic logo imprinted on the top or bottom surface. The graphic logo may be specific to the local region or may recognize the sponsorship of a entity, such as a corporate logo. The graphic logo may also be customizable, for example for use for a festival promotion. The postcard may also be purchased with prepaid postage affixed thereto, thus making the mailing of the postcard more convenient for the purchaser.

The present invention also discloses a method for preparation and delivery of the postcard. The method includes the steps of providing a wooden postcard, adding delivery information by means of a writing implement to the mailing graphic, adding a message by means of a writing implement to the message graphic, affixing postage to the top surface of the postcard in a sufficient amount to allow for mailing of the postcard by First Class U.S. Mail, and placing the postcard directly in the mail without further need for an envelope or exterior packaging. Optional steps include preparing the postcard by affixing a customized graphic logo to the top or bottom surface of the postcard.

Other features and advantages of the invention are described below.

### DETAILED DESCRIPTION OF THE DRAWINGS

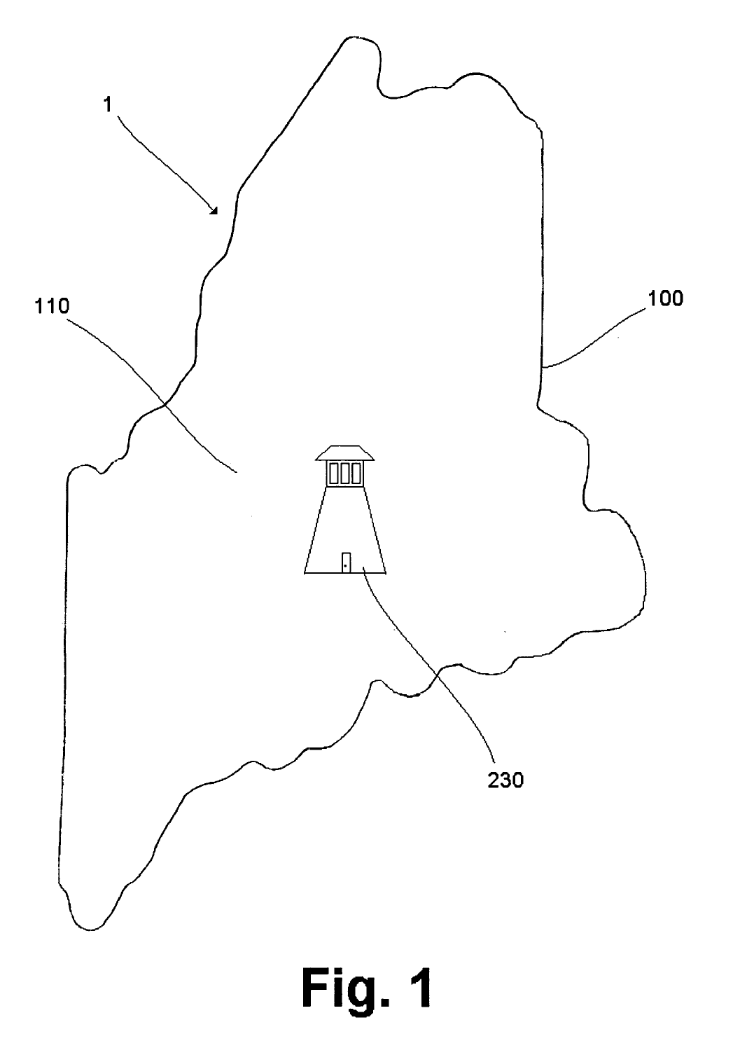

FIG. 1 is a top view of the present invention.

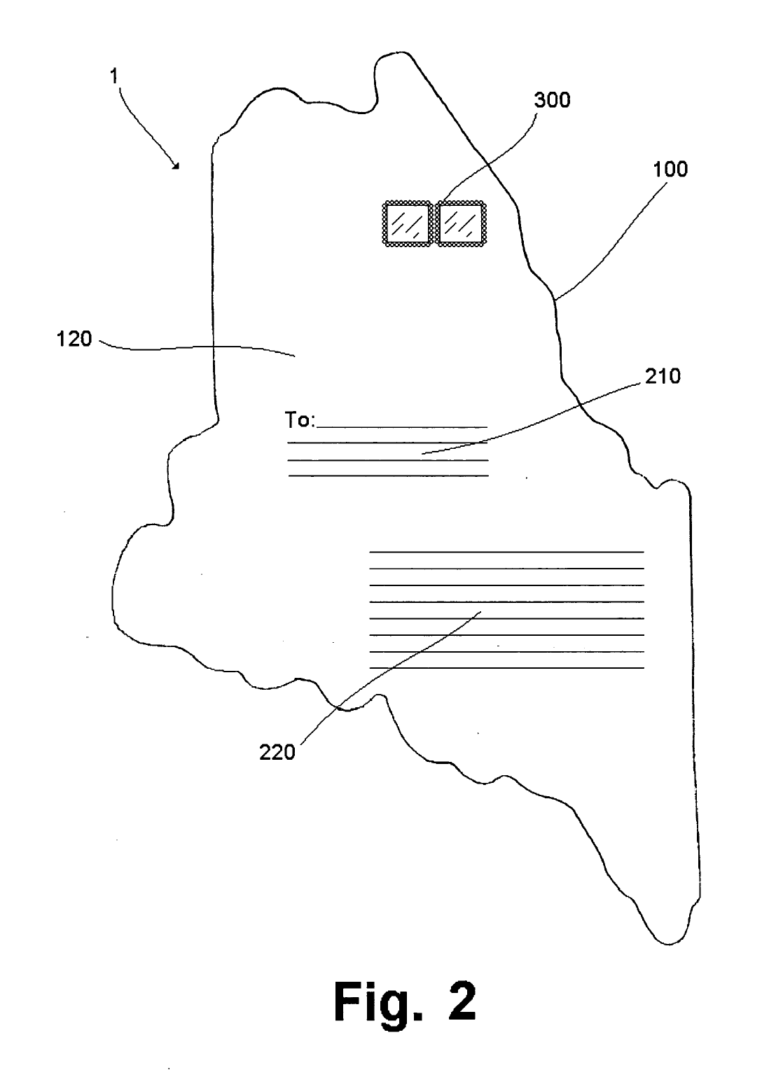

FIG. 2 is a bottom view of the present invention.

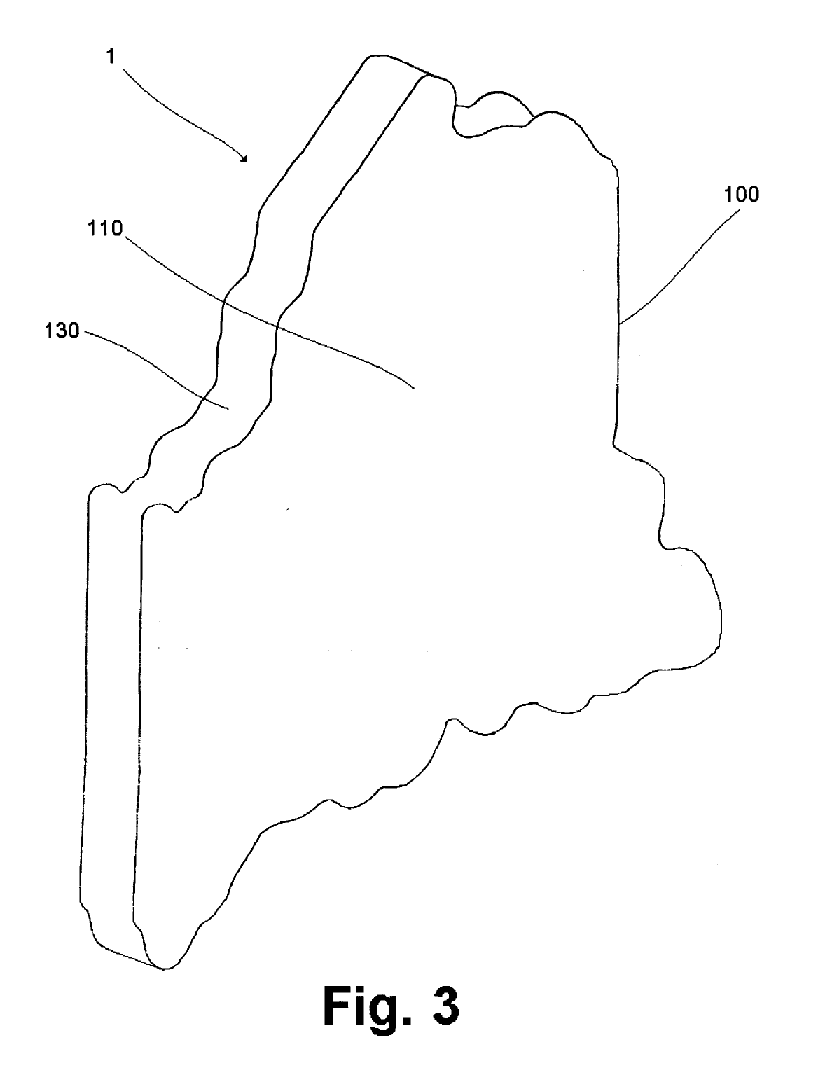

FIG. 3 is a perspective view of the present invention.

### DETAILED DESCRIPTION OF THE INVENTION

The improved postcard 1 of the present invention comprises a core member 100 made out of wood. The core member 100 has a top surface 110, a bottom surface 120, a circumferential edge 130, and a thickness. The top surface 110 of the core member 100 is substantially planar and lies within a first plane. The bottom surface 120 of the core member 100 is also substantially planar and lies within a second plane, whereby the second plane is spaced apart from and substantially parallel to the first plane. The bottom surface 120 has substantially the same shape as the top surface 110 of the core member 100. The circumferential edge 130 of the core member 100 defines the shape of the postcard 1 as a recognizable image in silhouette. The core member 100 has a substantially uniform thickness.

Affixed to the top surface 110 of the core member 100 is a mailing graphic 210. The mailing graphic 210 may be any suitable image that assists the user in adding mailing information to the postcard 1. For example, the mailing graphic 210 may comprise a box with horizontal lines therein upon which one may add the name and mailing address of the intended recipient. The mailing graphic 210 may also comprise a second box for the return address. The mailing graphic 210 may also contain instruction for the application of postage 300. Other embodiments of a mailing graphic 210 are also contemplated by this invention. Alternatively, the mailing graphic 210 may be affixed to the bottom surface 120 of the core member 100.

Also affixed to the top surface 110 of the core member 100 is a message graphic 220. The message graphic 220 may be any suitable image that assists the user in adding a message to the postcard 1. For example, the message graphic 220 may comprise a box with horizontal lines therein upon which one may add a message. Other embodiments of a message graphic 220 are also contemplated by this invention. Alternatively, the message graphic 220 may be affixed to the bottom surface 120 of the core member 100.

Configured as such, the postcard 1 is suitably adapted to be placed directly in the mails for delivery without need for an envelope or exterior packaging.

In the preferred embodiment the core member 100 is made out of a single piece of solid wood. The wood may be selected from any specie of tree, though locally grown trees are preferred. The wood is planed to create a smooth top surface 110 and bottom surface 120, then cut using a jigsaw or other suitable means for creating the circumferential edge 130. This method of manufacture lends itself to small business or cottage industry creation, which increases the desirability of the postcard 1 for use in the tourism industry. Alternatively, multi-layered wood, such as plywood, may be used for the core member 100.

The postcard 1 may have any suitable shape, as defined by the circumferential edge 130. In one embodiment the shape of the core member 100 is a silhouette of one of the fifty states of the United States of America. In another embodiment the shape of the core member 100 is a silhouette of a local landmark. In yet another embodiment the shape of the core member 100 is a silhouette of an animal head. These embodiments lend the present invention to use in the tourism industry. It is contemplated that a preferred embodiment of the present invention will be the outline of a state known for being heavily forested, such as Maine. In such circumstances, the wooden construction of the postcard 1 will reinforce the association with the state, increasing the desirability of the device.

In another embodiment of the present invention, the postcard 1 further comprises a graphic logo 230. The graphic logo 230 may be imprinted on either the top surface 110 of the core member 100 or the bottom surface 120, or both. The graphic logo 230 may be a corporate logo, or a design unique to a geographic location, or the like. The graphic logo 230 may also be customized, for use as a promotional device, such as a local festival or one time event.

In yet another embodiment of the present invention, the postcard 1 further comprises postage 300 affixed to the top surface 110 of the core member 100. The postage 300 is in a sufficient amount to allow for mailing of the postcard 1 by First Class U.S. Mail. This embodiment increases the convenience in use to the purchaser, who would not need to independently determine the correct amount of postage 300 for the postcard 1. In this embodiment, it is contemplated that the purchaser will purchase the postcard 1, add a message and mailing information, and then simply place the postcard 1 in a convenient mail box.

The present invention also discloses a method for preparation and delivery of a wooden postcard 1. The method comprises the steps of: providing the postcard 1 of the present invention; adding delivery information by means of a writing implement to the mailing graphic 210; adding a message by means of a writing implement to the message graphic 220; affixing postage 300 to the top surface 110 of the core member 100 in a sufficient amount to allow for mailing of the postcard 1 by First Class U.S. Mail; and placing the postcard 1 directly in the mail without further need for an envelope or exterior packaging. The first and last steps described above are in their required order, but all other steps may be done in any order.

In one embodiment of the foregoing method, the step of preparing the postcard 1 by affixing a customized graphic logo 230 to the core member 100 is added. This step precedes all other steps. The customized logo 230 may be affixed to either the top surface 110 or the bottom surface 120, or both, in any order.

In another embodiment of the foregoing method, the step of preparing the postcard 1 by forming the core member 100 into the shape of the state of Maine is added. This step precedes all other steps. The core member 100 may be formed into other shapes during this step, as well.

Other embodiments not specifically set forth herein are also within the scope of the following claims.

I claim:

1. A postcard comprising
a core member, said core member being made out of wood and having a top surface, a bottom surface, a circumferential edge, and a thickness, with the top surface of the core member being substantially planar and lying within a first plane,
the bottom surface of the core member being substantially planar and lying within a second plane, said second plane being spaced apart from and substantially parallel to said first plane, said bottom surface having substantially the same shape as the top surface of the core member,
the circumferential edge of the core member being adjacent to and substantially perpendicular to the top surface of the core member, and adjacent to and substantially perpendicular to the bottom surface of the core member, and
the thickness of the core member being substantially uniform, with said core member having a shape of a recognizable image in silhouette;
a mailing graphic affixed to the core member; and
a message graphic affixed to the core member;
whereby said postcard is suitably adapted to be placed directly in the mails for delivery without need for an envelope or exterior packaging.

2. The postcard of claim 1 wherein the shape of the core member is a silhouette of one of the fifty states of the United States of America.

3. The postcard of claim 1 wherein the shape of the core member is a silhouette of an animal head.

4. The postcard of claim 1 wherein the shape of the core member is a silhouette of a local landmark.

5. The postcard of claim 1 further comprising a graphic logo, said graphic logo imprinted on the top surface of the core member.

6. The postcard of claim 1 further comprising a graphic logo, said graphic logo imprinted on the bottom surface of the core member.

7. The postcard of claim 5 wherein the graphic logo is customized.

8. The postcard of claim 6 wherein the graphic logo is customized.

9. The postcard of claim 1 further comprising postage affixed to the top surface of the core member in a sufficient amount to allow for mailing of the postcard by First Class U.S. Mail.

10. The postcard of claim 7 further comprising postage affixed to the top surface in a sufficient amount to allow for mailing of the postcard by First Class U.S. Mail; wherein the shape of the core member is a silhouette of the state of Maine.

11. The postcard of claim 8 further comprising postage affixed to the top surface in a sufficient amount to allow for mailing of the postcard by First Class U.S. Mail; wherein the shape of the core member is a silhouette of the state of Maine.

12. A method for preparation and delivery of a postcard comprising the steps of:
providing the postcard of claim 1;
adding delivery information by means of a writing implement to the mailing graphic affixed to the core member;
adding a message by means of a writing implement to the message graphic affixed to the core member;
affixing postage to the top surface of the core member in a sufficient amount to allow for mailing of the postcard by First Class U.S. Mail; and
placing the postcard directly in the mail without further need for an envelope or exterior packaging.

13. The method of claim 12 further comprising the step of: preparing the postcard by affixing a customized graphic logo to the top surface of the core member, said step preceding all other steps.

14. The method of claim 12 further comprising the step of: preparing the postcard by affixing a customized graphic logo to the bottom surface of the core member, said step preceding all other steps.

15. The method of claim 12 further comprising the step of: preparing the postcard into the shape of the state of Maine, said step preceding all other steps.

16. The method of claim 13 further comprising the step of: preparing the postcard into the shape of the state of Maine, said step preceding all other steps.

17. The method of claim 14 further comprising the step of: preparing the postcard into the shape of the state of Maine, said step preceding all other steps.

18. A method for preparation and delivery of a postcard comprising the steps of:
providing the postcard of claim 9;
adding delivery information by means of a writing implement to the mailing graphic affixed to the core member;
adding a message by means of a writing implement to the message graphic affixed to the core member;
placing the postcard directly in the mail without further need for an envelope or exterior packaging.

19. The method of claim 18 further comprising the step of: preparing the postcard by affixing a customized graphic logo to the top surface of the core member, said step preceding all other steps.

20. The method of claim 18 further comprising the step of: preparing the postcard by affixing a customized graphic logo to the bottom surface of the core member, said step preceding all other steps.
